(19) United States
(12) Patent Application Publication
(10) Pub. No.: US 2010/0000430 A1
(43) Pub. Date: Jan. 7, 2010

(54) OFFSET PRINTING PROCESS

(75) Inventor: Axel Hauck, Karlsruhe (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AKTIENGESELLSCHAFT, Heidelberg (DE)

(21) Appl. No.: 12/496,723

(22) Filed: Jul. 2, 2009

(30) Foreign Application Priority Data
Jul. 2, 2008 (DE) 10 2008 030 960.5

(51) Int. Cl. B41L 23/02

(52) U.S. Cl. 101/147

(57) ABSTRACT

An offset printing process is carried out in an offset printing unit. Offset printing ink pre-emulsified with a dampening solution is supplied to the offset printing unit through an ink metering device and further dampening solution is supplied in the offset printing unit. The offset printing ink is applied to a printing form with at least one ink applicator roller and a printing material is printed with the offset printing ink. In this way, a subject-independent, constant margin from the smearing limit for offset printing is obtained.

### CROSS-REFERENCE TO RELATED APPLICATION

This application claims the priority, under 35 U.S.C. § 119, of German Patent Application 10 2008 030 960.5, filed Jul. 2, 2008; the prior application is herewith incorporated by reference in its entirety.

### BACKGROUND OF THE INVENTION

### Field of the Invention

The invention relates to an offset printing process which is carried out in an offset printing unit, in which offset printing ink pre-emulsified with a dampening solution is supplied to the offset printing unit through an ink metering device, the offset printing ink is applied to a printing form through the use of at least one ink applicator roller, and a printing material is printed with the offset printing ink. In conventional offset printing, offset printing units are used which include an inking unit and a dampening unit. The dampening solution supplied by the dampening unit has the task of keeping the printing form, in particular a printing plate, free in the non-printing regions and at the same time of supplying the printing ink with a sufficient quantity of dampening solution. In conventional dampening units, the requisite proportion of dampening solution which has to be supplied to the printing ink depends on the area coverage or the quantity of printing ink.

There already exist offset printing units with zonal dampening, for example spray dampening units, in which an attempt is made to adjust the quantity of dampening solution supplied zonally as required. However, in practice it is disadvantageous that dampening units of that type are structurally complicated and problems frequently occur with the necessary accuracy of the dampening solution metering.

When so-called single-fluid systems are used, the aim is to dispense entirely with the dampening unit and to achieve separation into non-printing and printing regions on the printing form using only one two-component printing ink. For the purpose of controllability of the emulsification, it is known, for example from European Patent Application EP 1 391 319 A2, corresponding to U.S. Pat. No. 6,834,590, to produce an emulsified ink through the use of the controlled supply of ink and dampening solution in the inking unit. It is also known, for conventional inking and dampening units, to mix dampening solution reaching the inking unit with the ink with the aid of an emulsifying apparatus (see, for example, European Patent Application EP 0 355 590 A2, corresponding to U.S. Pat. No. 4,962,015). In single-fluid systems, the operation of the offset printing unit is difficult in practice, since the free running of the printing form must be ensured by the proportion of dampening solution in the printing ink in all situations, such as continuous printing, machine stoppages, starting up the offset printing unit and the like.

Inking units frequently used for conventional offset printing are divided in the lateral direction (transversely with respect to the printing direction) into individual zones, in which various quantities of printing ink are supplied to the offset printing unit independently of one another. Since, typically, the supply of dampening solution is carried out uniformly in the lateral direction and is controlled merely through one actuating variable, the adjustment must necessarily be carried out in accordance with the requirements in the zones with high area coverage. As a consequence, the zones with low area coverage receive more dampening solution than necessary, so that printing problems result because of too high a proportion of dampening solution. Printing in an offset printing unit having inking zones with a different-sized proportion of dampening solution in the individual zones is therefore carried out only within a very small possible adjustment range. The smearing limits in the zones with different area coverage are different from one another.

### SUMMARY OF THE INVENTION

It is accordingly an object of the invention to provide an offset printing process, which overcomes the hereinafore-mentioned disadvantages of the heretofore-known processes of this general type and which achieves a subject-independent, substantially constant margin from a smearing limit.

With the foregoing and other objects in view there is provided, in accordance with the invention, an offset printing process carried out in an offset printing unit. Offset printing ink pre-emulsified with a dampening solution is supplied to the offset printing unit through an ink metering device. The offset printing ink is applied to a printing form, in particular a printing plate, through the use of at least one ink applicator roller, and a printing material is printed with the offset printing ink. According to the invention, further dampening solution is supplied to the printing form in the offset printing unit.

In other words, according to the invention, conventional offset printing is carried out with offset printing ink pre-emulsified with dampening solution. In particular, the area coverage-dependent dampening solution requirement is already emulsified into the offset printing ink. The further dampening solution supplied has the task of keeping the printing form free, no longer of supplying the offset printing ink with dampening solution. In this way, a subject-independent, constant margin from the smearing limit for offset printing is achieved.

Advantageously, two actuating variables are provided: the quantity of dampening solution which reaches the offset process through the offset printing ink, and the quantity of further dampening solution which additionally reaches the offset printing process. It is possible to achieve a uniform adjustment of the moisture through the variation of these two different quantities, in particular separate variation in each case. The invention makes it possible to achieve an optimized dampening adjustment in both the regions or zones with high area coverage and the regions or zones with low area coverage. Therefore, in all of the zones, the same margin from the smearing limit and thus a substantially greater value range for the quantity of dampening solution (dampening solution window) in the offset printing process is obtained. In particular, for very inhomogeneous printing forms, which is to say those with regions with a highly different area coverage, this possibility represents a very great advantage. The ink-moisture balance becomes more robust.

In other words, according to the invention the dampening solution supply is distributed to two paths: firstly, dampening solution emulsified into the offset printing ink is supplied to the offset printing process through the offset printing ink. Secondly, further dampening solution is supplied. This proportion can be influenced as previously in the offset printing process, in particular controlled or regulated. It is necessary to cover the range of fluctuation in the dampening solution requirement for the free running of the printing form, to stabilize the start-up, to reduce rejects and the like. The moisture control is simplified. Presetting of the moisture is made possible. It is possible to dispense with moisture readjustment.

The dampening solution can already be added and incorporated by the manufacturer of the offset printing ink. Alternatively, the dampening solution can also be introduced immediately before the filling of an ink reservoir, for example an ink fountain, or within the offset printing unit, through the use of an appropriate apparatus. An introduction close in time to the performance of the offset printing process has, inter alia, the advantage of control of the necessary quantity for offset printing.

The offset printing unit can in particular include a short-form inking unit. The offset printing unit can be part of a sheetfed printing press. The printing ink is supplied through the ink metering device as a function of area coverage. The quantity of dampening solution emulsified in can be selected as a function of the known dampening solution absorption of the offset printing ink. The printing material can in particular be paper, paperboard, board or organic polymer film.

As compared with conventional offset printing, zonal print quality problems, such as ghosting or tonal value gain, can be reduced.

In accordance with another mode of the invention, for the offset printing process, it is preferred for the proportion of dampening solution in the offset printing ink pre-emulsified with dampening solution to be chosen in such a way that, on the at least one ink applicator roller, the proportion of dampening solution from the offset printing ink lies below the smearing limit. In other words, the proportion of the dampening solution is lower than the quantity of dampening solution needed in order to overcome the smearing limit. Advantageously, the actuating variable of the further dampening solution supplied can be used for the adjustment of the working point, the ink-moisture ratio. This actuating variable can be adjusted more sensitively, more quickly and more precisely.

In accordance with a further mode of the invention, additionally or alternatively, for the offset printing process, it is preferred for the proportion of dampening solution in the offset printing ink pre-emulsified with dampening solution to be chosen in such a way that, in the event of loss of dampening solution from the pre-emulsified offset printing ink on the way from the ink metering device as far as the at least one ink applicator roller, the proportion of dampening solution reaches a predefined value on the at least one ink applicator roller. The loss is caused, for example, by evaporation.

In accordance with an added mode of the invention, in the offset printing process, the supply of further dampening solution can be carried out independently of the supply of offset printing ink pre-emulsified with dampening solution and/or through the use of at least one component of the offset printing unit that is different from the ink metering device. In particular, the supply of the further dampening solution can be carried out with the aid of a dampening unit of the offset printing unit.

In accordance with an additional mode of the invention, the offset printing process can be performed in a zonal offset printing unit: the ink metering device can have a plurality of individually actuable ink metering elements disposed in the lateral direction, with the quantity of ink supplied by an ink metering element being variable independently of the quantity of ink from another ink metering element.

In accordance with yet another mode of the invention, in the offset printing process, the supply of further dampening solution in the lateral direction of the offset printing unit can be carried out substantially with a constant quantity. It is possible for a zoneless dampening unit to be used.

In accordance with yet a further mode of the invention, in specific advantageous embodiments of the offset printing process, use is made of dampening solution in which the composition of the further dampening solution is different from the composition of the dampening solution emulsified into the offset printing ink. The dampening solution emulsified in can include additives through the use of which it is matched particularly well to its requirements. In particular, at least one additive can be used to promote the emulsification or to increase the quantity of dampening solution that can be absorbed.

In accordance with yet an added mode of the invention, in particular, the dampening solution and/or the further dampening solution can be free from isopropanol (IPA). Instead, the dampening solution can include alcohol substitutes. The offset printing ink can be curable with UV light. An improved print quality can be achieved due to the reduced dampening problems. The offset printing ink can be a familiar process ink (CMYK) or a special ink, in particular a metallic ink.

In accordance with yet an additional mode of the invention, in an advantageous further development, in the offset printing process the offset printing unit can be controlled by using at least one characteristic curve for a sequence, the characteristic curve for the offset printing with offset printing ink pre-emulsified with a dampening solution and with further dampening solution being adapted and the sequence being one from the group of sequences including ink presetting, ink input during job change, speed compensation for the dampening, speed compensation for the ink supply, pre-dampening and post-dampening.

In accordance with again another mode of the invention, additionally or alternatively, in the offset printing process, the supply of further dampening solution can be carried out under open-loop or closed-loop control for this purpose.

In accordance with yet a concomitant mode of the invention, a particularly advantageous further development of the offset printing process includes the quantity of dampening solution being measured at least at two mutually different positions at different distances from the printing form in the offset printing unit, and the quantity of further dampening solution supplied being regulated as a function of the measured values obtained.

Other features which are considered as characteristic for the invention are set forth in the appended claims.

Although the invention is illustrated and described herein as embodied in an offset printing process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram representing the progress of one embodiment of the offset printing process according to the invention;

FIG. 2 is a graph illustrating an example of a percentage area coverage in two zones as a function of a lateral position;

FIG. 3 is a graph illustrating an example of a quantity of ink associated with FIG. 2 in two zones as a function of the lateral position;

FIG. 4 is a graph illustrating an example of a quantity of dampening solution associated with FIG. 3 for conventional offset printing with zoneless dampening;

FIG. 5 is a graph illustrating an example of the quantity of dampening solution associated with FIG. 3 in the offset printing process according to the invention; and

FIG. 6 is a graph illustrating a proportion of moisture emulsified into the offset printing ink as a function of a position along an inking path through the inking unit.

### DETAILED DESCRIPTION OF THE INVENTION

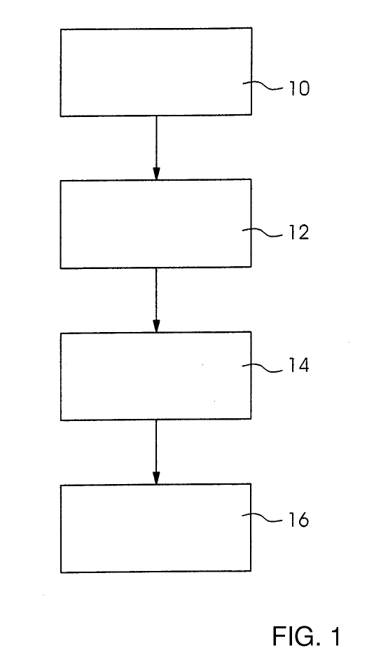

Referring now to the figures of the drawings in detail and first, particularly, to FIG. 1 thereof, there is seen a flow diagram representing the progress of an embodiment of the offset printing process according to the invention, which is carried out in an offset printing unit having an inking unit and a dampening unit. Offset printing ink pre-emulsified with a dampening solution is supplied through an ink metering device to an offset printing unit (ink supply 10) through the use of the inking unit. At the same time, further dampening solution is supplied through the use of the dampening unit (dampening solution supply 12). The offset printing ink and the further dampening solution are applied to a printing plate through the use of at least one ink applicator roller (application 14). A printing material, for example a board, is printed with the offset printing ink (printing 16), in such a way that the offset printing ink from the printing plate is transferred first to the surface of a rubber blanket on a blanket cylinder and then to the printing material.

The offset printing process can also be used for a multiplicity of different colors. In particular, standard four color printing (CMYK) with four offset printing units acting successively on the printing material can be provided.

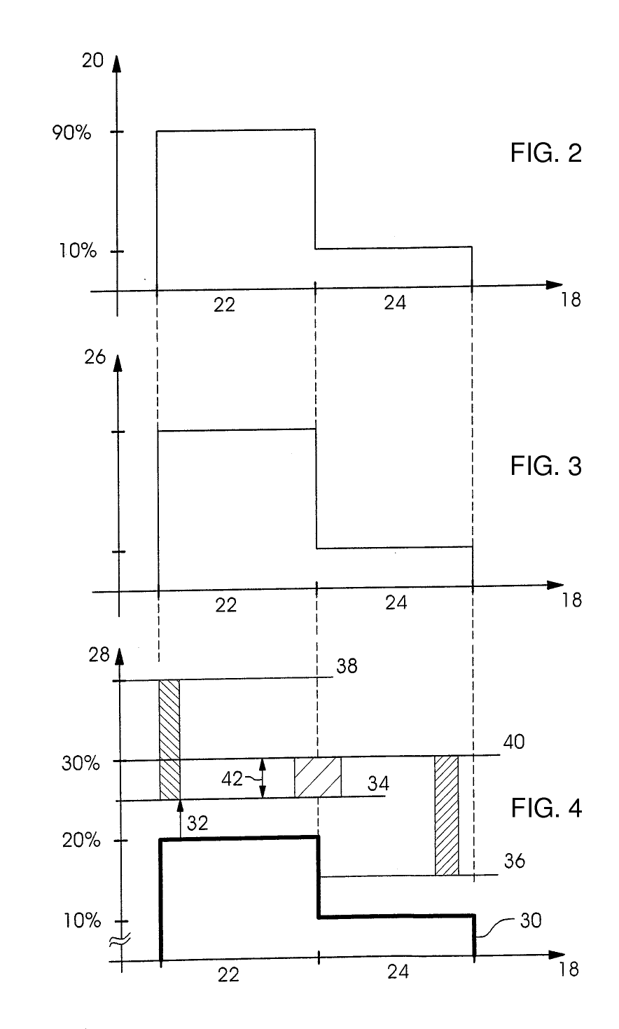

FIGS. 2 to 6 will be used in series in the following, by way of example, to explain the invention in relation to an inhomogeneous printing form having two inking zones as an example (without restricting the general number of inking zones in actually existing offset printing units).

FIG. 2 shows an example of a percentage area coverage 20 in two zones, namely a first inking zone 22 and a second inking zone 24, as a function of a position along a lateral direction 18. In this example, this involves a particularly inhomogeneous application of ink (inhomogeneous subject): in the first inking zone 22, an area coverage of 90% is required, and in the second inking zone 24, an area coverage of 10% is required.

FIG. 3 relates to an example of a quantity of ink 26 associated with FIG. 2 in the two zones as a function of the position along the lateral direction 18. While a relatively high quantity of ink is required in the first inking zone 22 in order to achieve the desired area coverage, a relatively low quantity of ink is needed in the second inking zone 24.

FIG. 4 shows an example of the quantity of dampening solution (quantitative in a percentage position of a moisture potentiometer) associated with the necessary quantity of ink shown in FIG. 3 for conventional offset printing in zoneless dampening, as a function of the position along the lateral direction 18. The moisture 28 is plotted in the graph as a function of the position along the lateral direction 18. The inhomogeneous subject on which FIGS. 2 and 3 are based has a smearing limit 30. By way of example, this smearing limit 30 is reached at 20% moisture 28 in the first inking zone 22 and at 10% moisture 28 in the second inking zone 24. In order to be able to print, a specific margin 32 from the smearing limit, for example quantitatively 5%, is required. It is clear that a minimum moisture 34 in the first inking zone 22 and a minimum moisture 36 in the second inking zone 24 differ from each other. Likewise, a maximum moisture 38 in the first inking zone 22 and a maximum moisture 40 in the second inking zone 24 at the exceeding of which the printing objective is no longer achieved, are different. As a result, a useful range for the adjustment of the moisture, a moisture window 42, is limited. The moisture window 42 can lie at most between the largest minimum value in one of the inking zones for the moisture 30 and the smallest maximum value in one of the inking zones for the moisture 30, in the overlap region. In the example shown, the moisture window 42 is therefore defined by the minimum moisture 34 in the first inking zone 22 and the maximum moisture 40 in the second inking zone 24. In conventional offset printing, the possible adjustments for the moisture in zoneless dampening are therefore restricted.

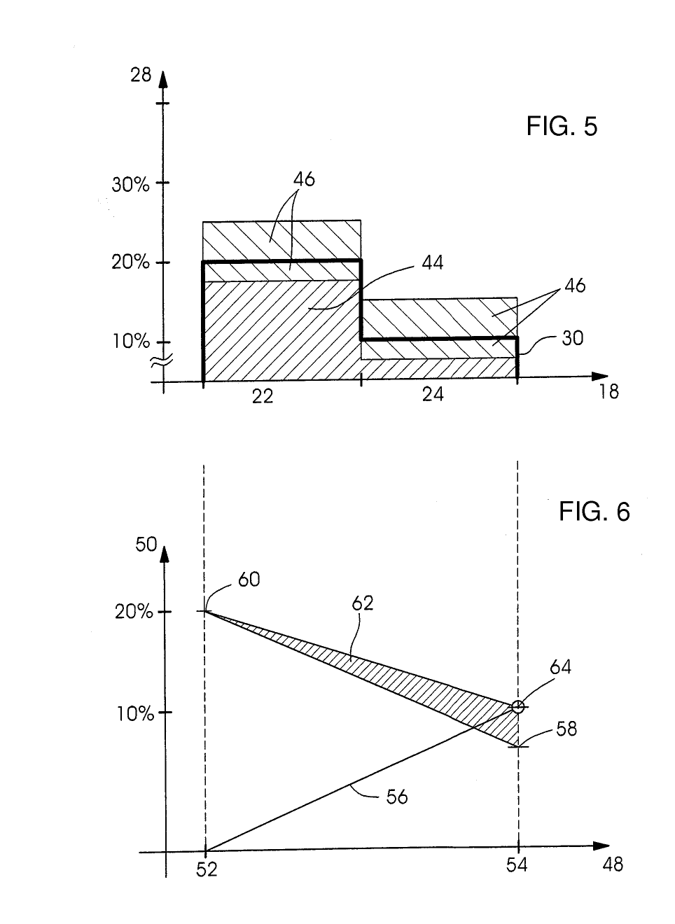

FIG. 5 shows an example of the quantity of dampening solution associated with the necessary quantity of ink shown in FIG. 3 (quantitatively in the percentage position of the moisture potentiometer) as a function of the position along the lateral direction 18 in the offset printing process according to the invention. It is possible to see the smearing limit 30 of the first inking zone 22 and the second inking zone 24 which, for the inhomogeneous subject discussed, is located quantitatively as in FIG. 4. According to the invention, a first proportion 44 of moisture is introduced into the offset printing unit through the pre-emulsified offset printing ink. This proportion 44 forms a base of moisture 28 and is zone-dependent, since the quantity of ink for the area coverage to be achieved is zone-dependent. According to the invention, it is particularly advantageous that this proportion 44 lies below the smearing limit 30. According to the invention, a second proportion 46 is further introduced into the offset printing unit, for example through the use of the dampening unit. This second proportion 46 is constant for all of the inking zones (transversely with respect to the printing direction, in the lateral direction). The total moisture from the first and second proportion 46 exceeds the smearing limit 30 in each of the inking zones. In the individual inking zones, printing is carried out with a different quantity of ink having mutually different moisture 28. In all of the inking zones, operations are carried out with the same margin from the smearing limit 30.

FIG. 6 illustrates a proportion of moisture 50 (in % by volume) emulsified into the offset printing ink as a function of a position 48 along the inking path through the inking unit from a position 52 of a first distributor (top position in the inking unit) and a position 54 of an ink applicator roller (bottom position in the inking unit). A conventional course 56 of the proportion of moisture emulsified in is firstly shown. In the case of conventional offset printing, the offset printing ink comes into contact with the dampening solution in the inking unit, so that use is made of emulsification having a quantitative extent that increases along the position 48 of the inking path until a working point 64 is reached at which the offset printing ink is applied to the printing plate. According to the invention, use is now made of offset printing ink into which dampening solution has already been emulsified. On the way through the inking unit, this offset printing ink loses dampening solution from an initial value 60, 20% by volume in this case by way of example at the position 52 of the first distributor, as far as the position 54 of the ink applicator roller. A target 58 for the proportion of moisture from the offset printing ink, as already mentioned with reference to FIG. 5, is a quantitative value below the smearing limit. Superimposed on the loss on the way through the inking unit is the uptake of further dampening solution which, according to the invention, is additionally supplied to the offset printing unit. The offset printing ink therefore gains a proportion of moisture 62 as a result of the action of the dampening unit, so that the working point 64 for the offset printing is achieved by the interaction of the two effects.

Finally, a few remarks should be made with regard to the suitable control of the offset printing unit for the offset printing process according to the invention. In order to utilize the advantages of the offset printing process according to the invention as comprehensively as possible, in an advantageous development, the machine control, in particular the control of ink and moisture, which is also controlled by the offset printing unit, is adapted to the conditions. This adaptation includes, amongst other things, the sequences: ink presetting, ink input at job change, moisture and possibly also ink speed compensation, pre-dampening (multiple phases) and post-dampening (multiple phases). The adaptation can be required both in the form of new characteristic curves and in the changing of individual parameters, such as the number of ductor cycles.

If, in specific embodiments of the offset printing process according to the invention, instead of a fixed proportion of the dampening solution in the offset printing ink, a change in the proportion of dampening solution is also considered, this additional parameter is also taken into account in adapting the control. It is incorporated in the structure of the characteristic curves as an additional variable. With regard to the decision as to which characteristic curve to use or which offset printing ink is present, the characteristic parameters, for example the proportion of dampening solution present in the offset printing ink in percent by volume (% vol.), can be made available to the machine control through the use of a manual entry by the printer. Provision can be made to use the offset printing unit optionally to print conventional offset printing ink or offset printing ink pre-emulsified with dampening solution. In this case, the machine control uses selectable conventional characteristic curves and parameters or characteristic curves and parameters adapted for the pre-emulsified offset printing ink. The selection can be made as a result of an entry by the printer (pre-emulsified ink (yes/no)). Alternatively, an automatic measurement of the moisture content in the offset printing unit, in particular in the ink reservoir, can also be made.

When defining the proportion of dampening solution in the offset printing ink, various factors must be taken into account. For a conventional offset printing ink with a moderate water absorption capacity, this appears as follows: on the ink applicator rollers, the proportion of moisture in the conventional offset printing process lies at around 10-15% by volume. It is preferable for the proportion of dampening solution in the printing ink as far as this point to have a somewhat lower value, for example 7-12% by volume, in order to ensure that the residual quantity can be supplied by the further dampening solution, for example by the dampening unit, so that a wide and robust dampening solution window can be achieved. Since moisture escapes from the emulsion in the inking unit as a result of the ink splitting, typically 10% by volume, the proportion of moisture in the offset printing ink must be set to a value between 17% by volume and 22% by volume.

For particular offset printing inks and dampening solution compositions, the following values have been determined for a preferred proportion of dampening solution:

| | |
|---|---|
| Mineral oil or bio oil inks | 10-30% by volume |
| with moderate water absorption | |
| Mineral oil or bio oil inks | 5-20% by volume |
| with low water absorption | |
| Special inks or metallic inks | 2-10% by volume |
| Alcohol-free printing without | 10-30% by volume |
| IPA in the dampening solution | |
| UV inks (scale and special inks) | 2-20% by volume |

In the printing process according to the invention, use can preferably be made of conventional printing inks with solvents based on bio or mineral oil. The dampening solution used can be conditioned water with additives, for example a dampening solution additive as in conventional printing. Contained substances in this case are, amongst other things, for example a buffer solution (for example citric acid), a complexing agent (for example phosphonates), a protective colloid (for example gum arabic), a biocide (for example Bronopol), a corrosion inhibitor (for example tolytriazole), a moisture retaining agent (for example glycerine), a surfactant and 2-propanol. Furthermore, there can be other substances in order to assist the emulsification, such as various surfactants or emulsion aids such as Surfadone.

In the case of closed-loop control of the proportion of dampening solution, the objective in the offset printing process according to the invention is to achieve an optimal overall process. The measured variable can be, for example, the proportion of moisture in the top and bottom region of the inking unit, which is to be regulated to a previously determined optimal target value or ratio value. If the proportion of moisture in the ink is also adjusted, the proportion of moisture is adapted simultaneously by the dampening unit, in order to ensure that the overall balance is equalized again.

1. An offset printing process carried out in an offset printing unit, the process comprising:
supplying offset printing ink pre-emulsified with a dampening solution to the offset printing unit with an ink metering device;
supplying further dampening solution to a printing form in the offset printing unit;
applying the offset printing ink to the printing form with at least one ink applicator roller; and
printing a printing material with the offset printing ink.

2. The offset printing process according to claim 1, which further comprises choosing the proportion of dampening solution in the offset printing ink pre-emulsified with dampening solution to cause the proportion of dampening solution from the offset printing ink on the at least one ink applicator roller, to lie below a smearing limit.

3. The offset printing process according to claim 1, which further comprises choosing the proportion of dampening solution in the offset printing ink pre-emulsified with dampening solution to cause the proportion of dampening solution to reach a predefined value on the at least one ink applicator roller, in the event of loss of dampening solution from the pre-emulsified offset printing ink on the way from the ink metering device as far as the at least one ink applicator roller.

4. The offset printing process according to claim 1, which further comprises carrying out the supply of further dampening solution independently of the supply of offset printing ink pre-emulsified with dampening solution.

5. The offset printing process according to claim 1, which further comprises carrying out the supply of further dampening solution independently of the supply of offset printing ink pre-emulsified with dampening solution and with at least one component of the offset printing unit different from the ink metering device.

6. The offset printing process according to claim 1, which further comprises carrying out the supply of further dampening solution with at least one component of the offset printing unit different from the ink metering device.

7. The offset printing process according to claim 1, which further comprises providing the ink metering device with a plurality of individually actuable ink metering elements disposed in lateral direction, and varying the quantity of ink supplied by an ink metering element independently of the quantity of ink from another ink metering element.

8. The offset printing process according to claim 1, which further comprises supplying the further dampening solution in lateral direction of the offset printing unit in a substantially constant quantity.

9. The offset printing process according to claim 1, wherein the composition of the further dampening solution is different from the composition of the dampening solution emulsified into the offset printing ink.

10. The offset printing process according to claim 1, wherein at least one of the dampening solution or the further dampening solution is free from isopropanol (IPA).

11. The offset printing process according to claim 1, wherein the offset printing ink is curable with UV light.

12. The offset printing process according to claim 1, which further comprises:
controlling the offset printing unit by using at least one characteristic curve for a sequence;
adapting the characteristic curve for the offset printing with offset printing ink pre-emulsified with a dampening solution and with further dampening solution; and
selecting the sequence from a group of sequences including ink presetting, ink input during job change, speed compensation for the dampening, speed compensation for the ink supply, pre-dampening and post-dampening.

13. The offset printing process according to claim 1, which further comprises carrying out the supply of further dampening solution under open-loop or closed-loop control.

14. The offset printing process according to claim 1, which further comprises:
measuring the quantity of dampening solution at least at two mutually different positions at different distances from the printing form in the offset printing unit to obtain measured values; and
regulating the quantity of further dampening solution supplied as a function of the measured values obtained.
